(19) United States
(12) Patent Application Publication
(10) Pub. No.: US 2005/0183284 A1
(43) Pub. Date: Aug. 25, 2005

(54) Dryer

(76) Inventors: Sung Gi Hwang, Changwon-si (KR); Il Tak Han, Suwon (KR); Jeung Gie Ahn, Seoul (KR); Dong Geun Lee, Changwon-si (KR)

Correspondence Address: MCKENNA LONG & ALDRIDGE LLP, 1900 K STREET, NW, WASHINGTON, DC, 20006, US

(21) Appl. No.: 11/111,738

(22) Filed: Apr. 22, 2005

Related U.S. Application Data
(62) Division of application No. 10/921,113, filed on Aug. 19, 2004.

(30) Foreign Application Priority Data
Dec. 6, 2003 (KR) P 2003-0088364
Dec. 6, 2003 (KR) P 2003-0088366

(51) Int. Cl. F26B 3/34; F26B 13/10

(52) U.S. Cl. 34/603; 34/524

(57) ABSTRACT

Disclosed is a dryer enabling a stable and easy installation of a power supply unit. The dryer includes: a housing; a drum rotatably installed inside the housing and configured to dry laundry; a heating unit for generating hot air and supplying the drum with the hot air to dry the laundry; a discharge unit for discharging the hot air in the drum to an outside; and an installation assembly formed integrally with a rear wall of the housing and configured to install a terminal block of a power supply unit at the rear wall.

This application claims the benefit of Korean Applications No. P2003-0088364, filed on Dec. 6, 2003 and No. P2003-0088366, filed on Dec. 6, 2003, which are hereby incorporated by reference.

### BACKGROUND OF THE INVENTION

1. Field of the Invention

The present invention relates to a clothing dryer, and more particularly, to an installation structure of a power supply unit in a dryer.

2. Discussion of the Related Art

Generally, a dryer is used to dry laundry washed by a washing machine using hot air. The dryer basically includes a drum for accommodating laundry, and a heating unit for supplying the drum with heated air. Since most of devices installed in the dryer are driven by an electric power, the dryer is provided with a power supply unit for stably supplying such devices with electricity. The power supply unit generally includes a power cord connected with an external power source, and a terminal installed in the dryer and electrically connected with the power cord. The terminal is electrically connected with the electric devices installed inside the dryer. To this end, the terminal is installed on a supply path of electricity such that the electricity is stably supplied to the electric devices. Also, for more stable power supply, a regulator may be installed as a part of the power supply unit between the terminal and the electric devices.

In such power supply units, since the terminal is installed at the dryer using a separate member for supporting the terminal, the installation of the terminal is complicated and needs many times. Also, it is general that a control panel of the dryer is disposed protruding from an upper rear of the dryer and the terminal is installed at a rear side of the protruded control panel. However, recently, the control panel is installed at a front portion of the dryer so as to reduce the volume of the dryer, and accordingly it is necessary to properly modify the installation position and structure of the terminal.

Also, since the power cord is installed in the dryer using a separate member such as a clamp, it requires lots of power and time to install the power cord.

### SUMMARY OF THE INVENTION

Accordingly, the present invention is directed to a dryer that substantially obviates one or more problems due to limitations and disadvantages of the related art.

An object of the present invention is to provide a dryer provided with a power supply unit that can be installed easily and simply.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dryer including: a housing; a drum rotatably installed inside the housing and configured to dry laundry; a heating unit for generating hot air and supplying the drum with the hot air to dry the laundry; a discharge unit for discharging the hot air in the drum to an outside; and an installation assembly formed integrally with a rear wall of the housing and configured to install a terminal block of a power supply unit at the rear wall.

Preferably, the installation assembly is positioned at an upper corner of the rear wall. Also, the installation assembly is configured to insert the terminal block into the rear wall. Preferably, the installation assembly is configured to install the terminal block at the rear wall so as not to be protruded from the rear wall.

The installation assembly includes: an opening formed at the rear wall and in which the terminal block is disposed; and at least one rib extending toward the opening from the rear wall and coupled with the terminal block. Preferably, the opening has an edge curled in an inward direction of the dryer. The rib includes first and second ribs coupled to both sides of the terminal block respectively, and is curved in an inward direction of the dryer.

Preferably, the installation assembly further includes a cover fixed to the rear wall, for covering the terminal block. The cover includes a protruded portion inserted into a hole formed in the rear wall, and a coupling hole coupled to the rear wall.

The installation assembly is configured to install a power cord respectively connected to the terminal block and a power, on the rear wall. Preferably, the installation assembly is formed at an upper corner so as to be adjacent to the terminal block.

Preferably, the installation assembly is configured to connect a power cord with the terminal block inside the dryer. For this purpose, the installation assembly includes an insertion hole formed in the rear wall and which a power cord is inserted into so as to be connected with the terminal block. Preferably, the insertion hole has an edge curled in an inward direction of the dryer.

Also, preferably, the installation assembly is configured to hold a power cord connected with the terminal block. In more detail, the installation assembly is configured to tightly fit a power cord connected with the terminal block in a rear wall. The installation assembly comprises a bush which is substantially installed at a power cord and tightly coupled on the rear wall. The bush comprises a body tightly inserted into an insertion hole formed in the rear wall, and a flange extending from the body and latched on the rear wall.

Preferably, the installation assembly further comprises a fixing member coupled with the bush such that the power cord is fixed on the rear wall. The fixing member is installed on an inner surface of the rear wall, and is coupled with the bush while crossing the bush. Preferably, the fixing member is configured to enclose at least a part of the bush. For this purpose, the fixing member comprises a cut-out portion engaged with the bush. Preferably, the bush comprises a recess into which the fixing member is inserted.

The installation assembly is configured to pull a power cord connected with the terminal block inward from the rear wall. In more detail, the fixing member is hung on an inner surface of the rear wall, and to elastically pull the bush in an inward direction of the dryer. For this purpose, the fixing member is engaged with the bush while being elastically deformed, and is curved.

Alternatively, the installation assembly may have an auxiliary insertion hole for a power cord directly connected with inner devices of the dryer without the terminal block. Preferably, the auxiliary insertion hole is formed at an upper corner of the rear wall. Also, the auxiliary insertion hole is closed, and is opened if necessary. Substantially, the auxiliary insertion hole comprises a cover covering the auxiliary insertion hole, and a rib connecting the cover with the rear wall and configured to be able to be cut.

According to the above-described present invention, the power supply unit including the terminal block and the power cord can be installed at the dryer rigidly and easily.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a dryer according to the present invention;

FIG. 2 is a disassembled perspective view of main parts of a dryer according to the present invention;

FIG. 3 is a rear view of a dryer illustrating an installation assembly of a power supply unit according to the present invention;

FIG. 4 is a partial disassembled perspective view illustrating an installation assembly for a terminal of a power supply unit according to the present invention;

FIG. 5 is a partial sectional view of an installation assembly for a power cord of a power supply unit according to the present invention; and

FIG. 6 is a plane view of the fixing member of FIG. 5.

### DETAILED DESCRIPTION OF THE PREFERRED EMBODIMENTS

Reference will now be made in detail to the preferred embodiments of the present invention, examples of which are illustrated in the accompanying drawings.

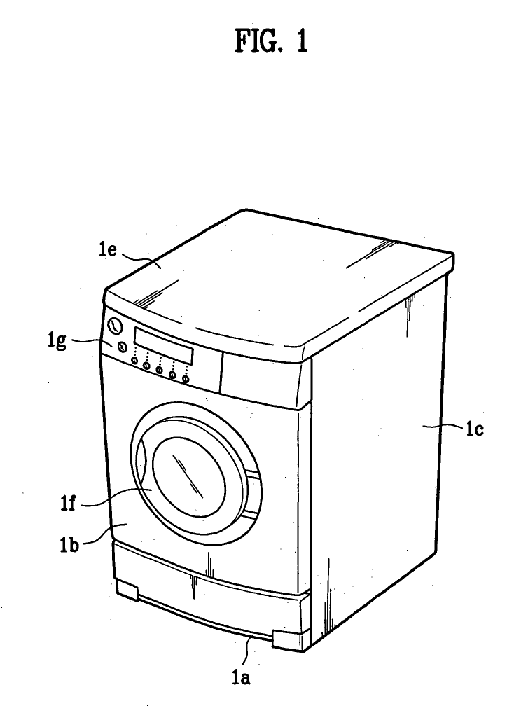

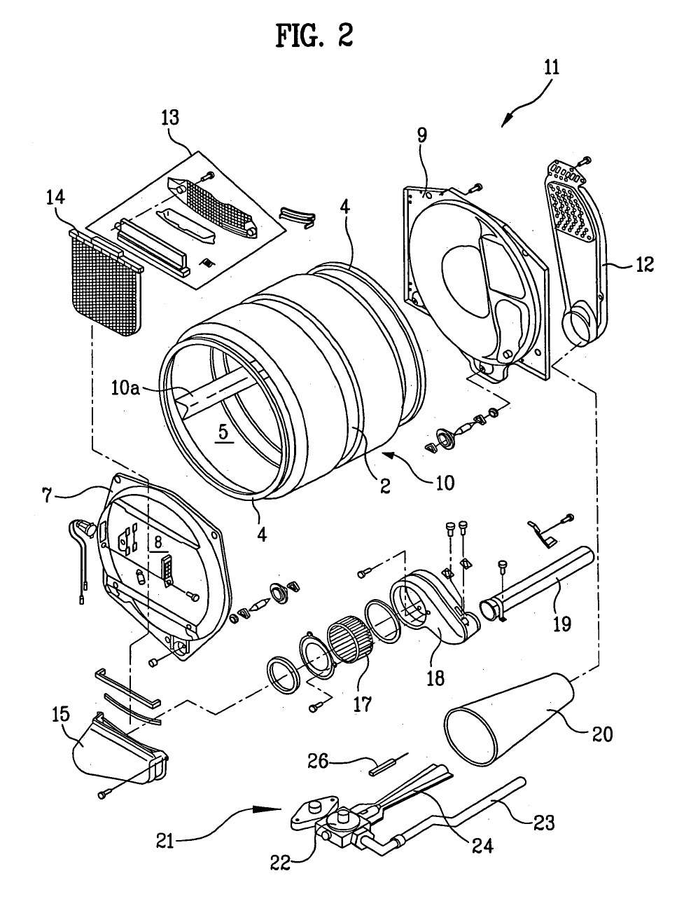

FIG. 1 is a perspective view of a dryer according to the present invention, and FIG. 2 is a disassembled perspective view of main parts of a dryer according to the present invention.

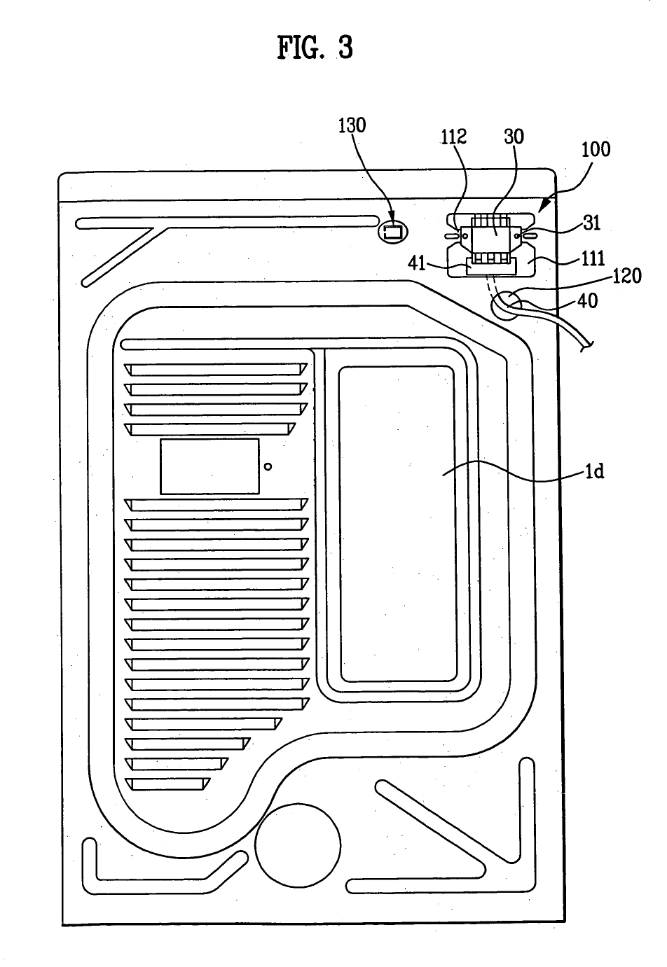

As shown in FIG. 1, the dryer has a housing 1 configured to house a variety of parts. The housing 1 includes a base panel 1a, a front panel 1b, side panels 1c, a rear panel 1d (see FIG. 3), and a top panel 1e. The side panels 1c and the rear panel 1d are disposed upright on the base panel 1a, and the top panel 1e is installed on the side panels 1c and the rear panel 1d. The front panel 1b is disposed at a front side of the side panels 1c. The front panel 1b, the side panels 1c, and the rear panel 1d form a front wall, side walls, and a rear wall of the dryer. In more detail, the front panel 1b has an opening (not shown) for loading or unloading laundry into or from the dryer, and a door 1f rotatably installed to open and close the opening. Since the opening communicates with a drum 10 (see FIG. 2) to be described later, the door 1f substantially opens or closes the drum 10. At an upper portion of the housing 1, accurately between the front panel 1f and the top panel 1e, a control panel 1g is installed. Accordingly, a user can command operations or control functions of the dryer using the control panel 1g. Compared with the related art control panel formed protruding at a rear side of the top panel 1e, the control panel 1g reduces the volume of the dryer and enhances the appearance of the dryer.

A variety of parts are installed inside the housing 1 as shown in FIG. 2. First, the drum 10 is driven by a separate driving source, and is rotated by a belt (not shown) wound on a belt groove 2 formed in an outer circumferential thereof. A dry chamber 5 is disposed inside the drum 10 to accommodate and dry the laundry. Also, at least one lifter 10a is formed on an inner circumferential surface of the drum 10. The lifter 10a lifts the laundry loaded in the dry chamber 5 up to a predetermined height while the drum 10 rotates. After that, the laundry drops from the lifter 10a by self-weight. Accordingly, the lifter 10a allows the laundry to be exposed uniformly to hot air, thereby accelerating drying.

A front head 7 and a rear head 9 are installed in front and rear of the drum 10. Accordingly, as illustrated, the drum 10 has opened both ends, that is, opened front and rear ends. However, according to a product specification, the rear end may be closed. The front head 7 and the rear head 9 support front and rear ends of the rotating drum 10, respectively. At this point, a sealing member 4 for preventing leakage is installed between the front head 7 and the drum 10 and between the rear head 9 and between the rear head 9 and the drum 10, which are relatively rotated. An inlet port 8 is formed at the front head 7 to communicate the dry chamber 5 with the external. The inlet port 8 is selectively opened and closed by a door (1f of FIG. 1).

A discharge assembly is installed at the drum 10, and extends from the front head 7 to the external of the dryer. The discharge assembly functions to discharge heated air used for drying the laundry, to the external of the dryer. The discharge assembly includes an outlet port assembly 13, a lint filter 14, a lint duct 15, a blower 17 and a discharge pipe 19. In more detail, the outlet port assembly 13 comprised of a plurality of parts is installed at a lower end of the inlet port 8 of the front head 7 to discharge air from the dry chamber. The lint filter 14 is installed at the outlet port assembly 13. The lint filter 14 filters a foreign material (waste yarn or dust) mixed with air escaping from the drying chamber 5. The lint duct 15 is installed to communicate with the outlet port assembly 13. The lint filter 14 is disposed over the internal of the lint duct 15 and the outlet port assembly 13. The blower 17 is connected with the lint duct 15, thereby sucking an internal air of the dry chamber 5 through the lint duct 15. The blower 17 is installed within a blower housing 18. The blower housing 18 has one end communicating with the lint duct 15, and the other end connecting with the discharge pipe 19. Accordingly, the blower 17 discharges the air, which escapes from the dry chamber 5 and then passes through the lint duct 15, through the discharge pipe 19 to the external.

A heating unit is installed at the rear head 9 to heat and supply air to the chamber 5 of the drum 10. In the heating unit, an air supplying duct 12 is installed at the rear head 9. The air supplying duct 12 functions as a passage through which the heated air is supplied to the internal of the dry chamber 5. Additionally, a hot air duct 20 is connected with the air supplying duct 12. The hot air duct 20 induces hot air to the internal of the dry chamber 5. For this, a gas nozzle 22 of a gas burner 21 is installed at an inlet port of the hot air duct 20. The gas nozzle 22 functions to spray the supplied gas. The gas nozzle 22 includes a valve for controlling the supply of the gas. A reference numeral 23 denotes a gas pipe. A mixing pipe 24 is extended from the inlet port to the internal of the hot air duct 20 to mix gas sprayed from the gas nozzle 22 with a primary air. Inside the mixing pipe 24, the gas sprayed from the gas nozzle 22 is mixed with an external air introduced through an inlet port of the mixing pipe 24, that is, the primary air. A spark plug 26 is installed at a front end of the mixing pipe 24 to generate ignition spark. Alternatively, a heating unit capable of generating hot air using hot wire heated by electricity may be used instead of the gas burner 21.

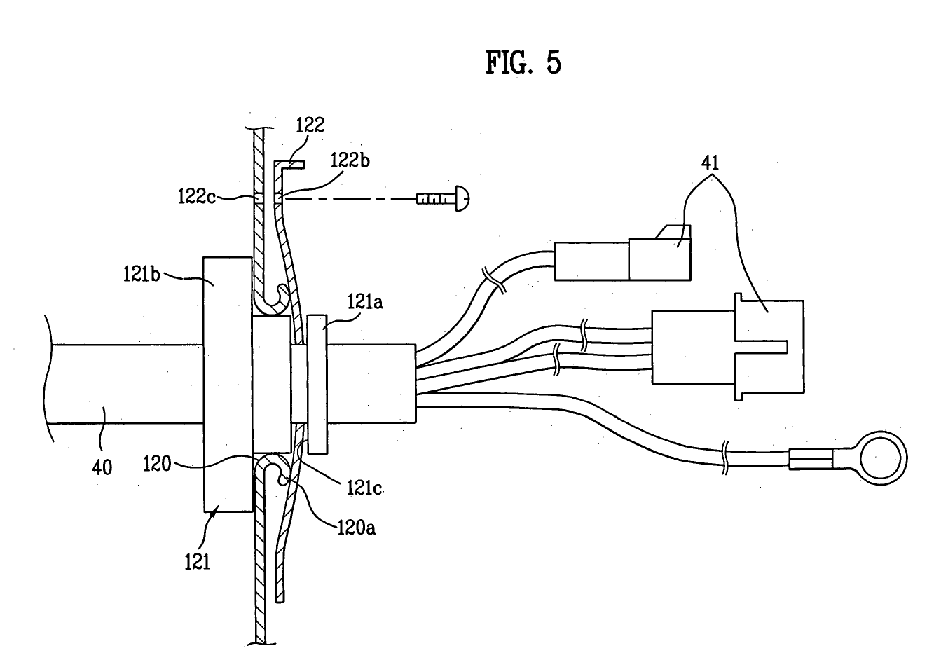

The above-described parts of the dryer are driven by electricity. So, a power supply unit for supplying necessary electricity to the respective parts is installed at the dryer. The power supply unit is basically installed at the dryer, and includes terminals 30 electrically connected with the respective parts, and a power cord 40 connecting the terminals 30 with an external power source. The dryer has the plurality of terminals 30 so as to supply electric powers to the respective parts. The respective terminals 30 are integrated as a single terminal block so as to be connected with the power cord 40 with ease. The terminal block 30 enables a stable supply of electricity to the respective parts. The power cord 40 has a connector 41 (see FIG. 5) that electric wires for supplying power to the respective terminals are made in a single part for the connection with the terminal block 30. The power cord 40 may be directly connected with inner electric parts of the dryer without the terminal block 30. However, a distance between the dryer and an external power source may be changed depending on an installation position of the dryer. Accordingly, when the terminal block 30 is installed at the dryer, the power cord 40 having a proper length depending on the distance can be employed in the dryer, i.e., between the terminal block 30 and the external power source. In other words, by using the terminal block 30 and the power cord 40, electricity can be stably supplied to the dryer irregardless of the installation position of the dryer. To install the power supply unit at the dryer, the dryer has an installation assembly 100 properly designed. In the installation assembly 100, a structure for the terminal block 30 that is a main part of the power supply unit will now be described in detail.

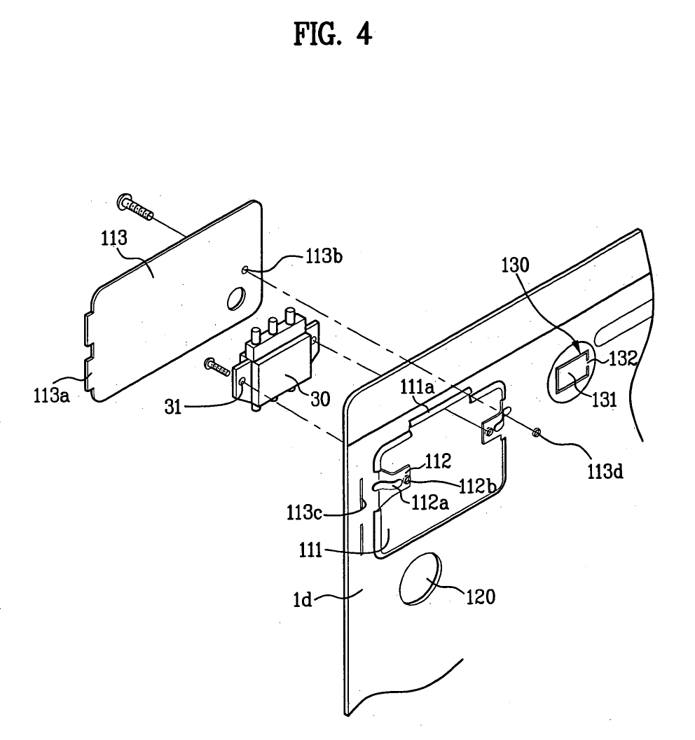

FIG. 3 is a rear view of a dryer illustrating an installation assembly of a power supply unit according to the present invention, and FIG. 4 is a partial disassembled perspective view illustrating an installation assembly for a terminal of a power supply unit according to the present invention.

As shown in FIG. 3, the terminal block 30 is disposed at a rear side of the dryer along with the power cord 40 so as not to be exposed to a user. Hence, the installation assembly 100 is disposed at a rear wall of the dryer, i.e., at the rear panel 1d. As aforementioned, for better appearance, the control panel 1g is disposed at the upper portion of the front panel 1b of the dryer, and the terminal block 30 is preferably disposed as close to the control panel 1g as possible so as to be functionally connected with the control panel 1g. Accordingly, it is preferable that the installation assembly 100 is disposed at an upper portion of the rear panel 1d. Also, the rear panel 1d is provided with an inlet port for sucking heated air, or other accessories. To avoid interference with the inlet port or other accessories, it is most preferable that the installation assembly 100, in particular, a structure for the installation of the terminal block 30 is disposed at any one of upper corners of the rear panel 1d as shown in FIG. 3.

The installation assembly 100 is formed as one body with the rear panel 1d so as to install the terminal block 30 at the rear panel 1d with ease without using an additional member. In more detail, the installation assembly 100 includes an opening 111 formed in the rear panel 1d, and a rib 112 extending from the rear panel 1d for the installation of the terminal block 30 as shown in FIG. 4.

The opening 111 is formed in a larger size than the terminal block 30, and the terminal block 30 is disposed in the opening 111. Accordingly, a clearance communicating with an inner space of the dryer is formed between the opening 111 and the terminal block 30, so that it becomes easy to install and exchange the terminal block 30 and to connect the terminal block 30 with the power cord 40. Also, since the opening 111 is generally formed shearing the rear panel 1d, its edge 111a is sharp. To this end, it is preferable that the edge 111a be curled toward an inside of the dryer such that a user does not get a wound by the edge 111a.

The rib 112 extends to an inside of the opening 111 from the rear panel 1d, and is then coupled with the terminal block 30. The rib 112 includes first and second ribs facing each other, and is coupled to the terminal block 30 at both sides of the terminal block 30, thereby stably supporting the terminal block 30. Also, the rib 112 is bent toward the inside of the dryer. The curved rib 112 becomes an angle bracket to which the terminal block 30 is supported and coupled as shown in FIG. 4. Accordingly, the terminal block 30 is inserted into the opening 111, i.e., into the rear panel 1d using the opening 111 and the curved rib 112, so that appearance of the rear panel 1d of the dryer is enhanced. Also, if the terminal block 30 is protruded from the rear panel 1d, the terminal block 30 is like to collide with an external body during the installation or use of the dryer, so that the terminal block 30 may be fractured due to its low strength. Accordingly, it is preferable that the terminal block 30 is completely inserted into the opening 111 so as not to be protruded from the rear panel 1d. For the above arrangement of the terminal block, the depth of the curved rib 112 is properly controlled. Also, to reinforce the strength of the curved portion, it is preferable that the rib 112 includes a bead 112a. The bead 112a includes a coupling hole 112b. The rib 112 is coupled with the terminal block 30 using the coupling hole 112b, the coupling hole 31 of the terminal block 30, and a predetermined coupling member. A burr extending to the inside of the dryer is formed around the coupling hole 112b to guide a coupling of the coupling member.

Although the terminal block 30 is inserted into the opening 111 so as not to be protruded, the terminal block 30 is partially exposed. To this end, if water is penetrated into the terminal block 30, the terminal block 30 may be disordered due to a short circuit. Also, if a user contacts the terminal block 30, the user may be electrically shocked. To completely protect the terminal block from water or the like, the installation assembly further includes a cover 113 covering the terminal block 30. The cover 113 is fixed to the rear panel 1d as shown in the drawings, and is formed larger than the opening 111 so as to close the opening 111 accommodating the terminal block 30. In more detail, the cover 113 includes a protruded portion 113a and a coupling hole 113b so as to be fixed to the rear panel 1d. Around the opening 111 of the rear panel 1d, a slot 113c corresponding to the protruded portion 113a, and a coupling hole 113d corresponding to the coupling hole 113b are respectively formed. Also, around the coupling hole 113d of the rear panel 1d, a burr is formed like in the coupling hole 112d of the rib. Accordingly, the protruded portion 113a is first inserted into the slot 113c such that the cover 113 is supported by the rear panel 1d as a whole, and then the cover 113 is rigidly fixed to the rear panel 1d using the communicating coupling holes 113b and 113d, and a coupling member.

Also, the installation assembly 100 is additionally configured to install the power cord 40 on the rear panel. Herein, the power cord 40 is another element for stable installation of the power supply unit at the dryer. A detailed structure for the installation of the power cord 40 will be now described with reference to the accompanying drawings.

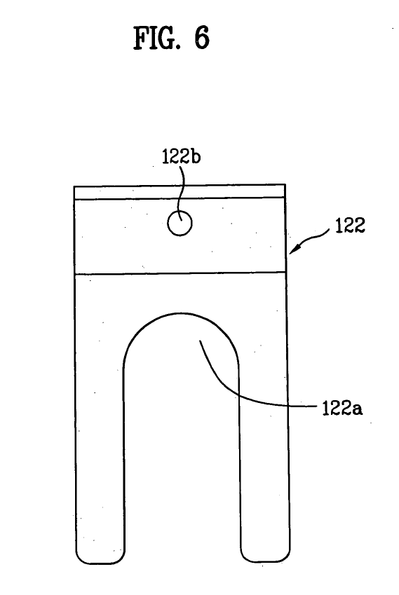

FIG. 5 is a partial sectional view of an installation assembly for a power cord of a power supply unit according to the present invention, and FIG. 6 is a plane view of the fixing member of FIG. 5.

Referring to FIGS. 5 and 6, it is preferable that the power cord 40 be installed adjacent to the terminal block 30 for the connection with the terminal block 30 and at the same time the power cord 40 does not interfere with the accessories of the rear panel 1d. Accordingly, like in the structure for the installation of the terminal block 30 shown in FIG. 3, the installation assembly 100 for the installation of the terminal block 30 is disposed at any one of upper corners of the rear panel 1d. Also, if the power cord 40 is connected with the terminal block 30 outside the dryer, their connection portion is exposed. To this end, due to various reasons, for example, external force applied to the connection portion, the power cord 40 may be separated from the terminal block 30. Accordingly, the installation assembly 100 is configured such that the power cord 40 is connected with the terminal block 30 inside the dryer. Thus, the installation assembly 100 used for the inner connection includes an insertion hole 120 formed in the rear panel 1d. The insertion hole 120 is formed adjacent to the terminal block 30 such that the power cord 40 is easily connected with the terminal block 30. As shown in FIG. 5, the power cord 40 is inserted into an inside of the dryer through the insertion hole 120, and a connector 41 formed at one end thereof is connected with the terminal block 30. Accordingly, the connection portion of the power cord 40 and the terminal block 30 is protected inside the dryer so as not to be separated. Also, since the insertion hole 120 is formed as one body with the lead panel 1d, the power cord 40 is installed at the rear panel 1d without any separate member.

The inserted power cord 40 may be moved inside the insertion hole 120 if the size of the insertion hole 120 is larger than a sectional area of the power cord 40. To hold the power cord 40, the installation assembly 100 further includes a bush 121 coupled to the power cord 40. The bush 121 is tightly coupled to the insertion hole 120 such that the power cord 40 is not moved inside the insertion hole 120. In more detail, the bush 121 has a body 121a and a flange 121b extending from the body 121a. The body 121a has almost the same size as the insertion hole 120, and is tightly inserted into the insertion hole 120. The flange 121b is made larger than the insertion hole 120 to be latched on the rear panel 1d, thereby restricting an insertion of the power cord 40. Accordingly, the power cord 40 is tightly fitted in the rear panel 1d by the bush 121.

To fix the power cord 40 to the rear panel 1d, the installation assembly 100 further includes a fixing member 122. As shown in FIG. 5, the fixing member 122 is disposed within the dryer, and is coupled with an insertion portion of the bush 121, i.e., the body 121a. In more detail, the fixing member 122 is made in the form of a plate member, and is coupled with the bush 121 while crossing the bush 121. The fixing member 122 is configured to enclose at least a part of the inserted body 121a so as to be coupled with the power cord 40. That is, the fixing member 122 includes a cut-out portion 122a having a predetermined size and into which the body 121a is inserted as shown in FIG. 6. Also, it is preferable that the body 121a includes a recess 121c. As the fixing member 122, exactly speaking, an edge of the cut-out portion 122a is inserted into the recess 121c, the fixing member 122 is more rigidly coupled to the body 121a. Also, as shown in FIG. 5, the fixing member 122 is slightly curved and whereby the fixing member 122 is tightly fitted in the recess 121c. Accordingly, when the fixing member 122 is coupled with the body 121a, the flange 121b is latched on an outer surface of the rear panel 1d, and the fixing member 122 is latched on an inner surface of the rear panel 1d. Accordingly, the bush 121 is substantially supported by both the outer surface and the inner surface of the rear panel 1d by using the flange 121b and the fixing member 122, so that the power cord 40 coupled with the bush 121 is fixed to the rear panel 1d. Also, when the fixing member 122 is coupled with the bush 121, the curved portion of the fixing member 122 is elastically deformed. Accordingly, while the fixing member 122 is supported by the inner surface of the rear panel 1d, the curved portion pulls the bush toward the inside of the dryer. Accordingly, the flange 121b is closely in contact with the outer surface of the rear panel 1d and the power cord 40 is more rigidly fixed. Coupling holes 122b and 122c communicating with each other are respectively formed at the fixing member 122 and the rear panel 1d, and the fixing member 122 can be fixed to the rear panel 1d using a coupling member.

The heating units for heating air are classified into electrical heating units and gas heating units as described above. Since the electrical heating units need massive electricity, the terminal block 30 is employed for the safety of a user. In the meanwhile, since the gas heating units need a relatively small amount of electricity, the terminal block is not employed. Accordingly, in the case of the dryers having the gas heating unit, the power cord 40 is directly connected with the inner electrical parts. The power cord 40 directly connected with the electrical parts needs a separate insertion hole. Accordingly, the rear panel 1d is separately made suitable for the power cord 40 for the gas heating unit. However, when the rear panel 1d is made separately, production costs rise. Hence, it is preferable that the rear panel 1d is designed to have both the insertion hole for the electrical heating unit and the insertion hole for the gas heating unit. Accordingly, the installation assembly 100 provided in the rear panel 1d further includes an auxiliary insertion hole 130 through which the power cord, which is employed for the gas heating unit and directly connected with the inner electrical parts of the dryer, is inserted as shown in FIG. 2.

The auxiliary insertion hole 130 is formed spaced apart by a predetermined distance from the opening 111. Due to the same reason as the opening 111 and the insertion hole 120, the auxiliary insertion hole 130 is formed at any one of upper corners of the rear panel 1d. Also, the auxiliary insertion hole is configured to be closed, and to be opened if necessary. In more detail, as shown in FIG. 4, the auxiliary insertion hole 130 is covered by a cover 131, and the cover 131 is connected with the rear panel 1d by a rib 132. The rib 132 is made thin and weak so that it may be easily cut if necessary. Accordingly, when the dryer has an electrical heating unit, the auxiliary insertion hole 130 is closed and the insertion hole 120, the opening 111 and the rib 112 are used for the installation of the terminal block 30 and the power cord 40. Alternatively, when the dryer has a gas heating unit, the rib 132 is cut and the cover 131 is removed such that the auxiliary insertion hole 130 is opened. After that, the power cord for the gas heating unit is inserted into the auxiliary insertion hole 130 so as to be directly coupled with the inner electrical parts. Thus, since the installation assembly 100 further includes the auxiliary insertion hole 130, the installation assembly 100 and the rear panel 1d have compatibility with respect to both the dryer having the electrical heating unit and the dryer having the gas heating unit.

As described above, by employing the installation assembly according to the present invention, the power supply unit can be installed without any interference with other parts of the dryer, rigidly, easily and simply. Also, the installation assembly is formed as one body with the rear panel without many additional parts, and has a simple structure. Accordingly, the productivity of the dryer is increased, and the production cost is reduced.

Further, the installation assembly positions the power supply unit at the rear panel, i.e., at an upper portion of the rear wall of the housing. Accordingly, the installation assembly of the present invention is more suitable in functionally connecting the power supply unit with the control panel disposed at an upper portion of the front wall of the housing.

It will be apparent to those skilled in the art that various modifications and variations can be made in the present invention. Thus, it is intended that the present invention covers the modifications and variations of this invention provided they come within the scope of the appended claims and their equivalents.

1-36. (canceled)

37. A dryer comprising:
a housing;
a drum rotatably installed inside the housing and configured to dry laundry;
a heating unit for generating hot air and supplying the drum with the hot air to dry the laundry;
a discharge unit for discharging the hot air in the drum to an outside; and an installation assembly formed at a rear wall of the housing and configured to install a power cord connected with an external power at the rear wall so as to allow the power cord to be connected with a terminal block inside the dryer.

38. The dryer of claim 37, wherein the installation assembly is positioned at any one of upper corners of the rear wall.

39. The dryer of claim 37, wherein the installation assembly comprises an insertion hole formed in the rear wall and allowing the power cord to be inserted therein so as to be connected with the terminal block.

40. The dryer of claim 39, wherein the insertion hole has an edge curled toward an inside of the dryer.

41. The dryer of claim 37, wherein the installation assembly is configured to hold a power cord connected with the terminal block.

42. The dryer of claim 37, wherein the installation assembly is configured to tightly fit a power cord connected with the terminal block in a rear wall.

43. The dryer of claim 37, wherein the installation assembly comprises a bush which is installed at a power cord and tightly coupled on the rear wall.

44. The dryer of claim 43, wherein the bush comprises a body tightly inserted into an insertion hole formed in the rear wall, and a flange extending from the body and latched on the rear wall.

45. The dryer of claim 37, wherein the installation assembly comprises a fixing member coupled with the power cord such that the power cord is fixed on the rear wall.

46. The dryer of claim 43, wherein the installation assembly comprises a fixing member coupled with the bush such that the power cord is fixed on the rear wall.

47. The dryer of claim 45, wherein the fixing member is installed on an inner surface of the rear wall.

48. The dryer of claim 46, wherein the fixing member is coupled with the bush while crossing the bush.

49. The dryer of claim 46, wherein the fixing member is configured to enclose at least a part of the bush.

50. The dryer of claim 46, wherein the fixing member comprises a cut-out portion engaged with the bush.

51. The dryer of claim 46, wherein the bush comprises a recess into which the fixing member is inserted.

52. The dryer of claim 37, wherein the installation assembly is configured to pull a power cord connected with the terminal block inward from the rear wall.

53. The dryer of claim 45, wherein the fixing member is latched on an inner surface of the rear wall.

54. The dryer of claim 46, wherein the fixing member is configured to elastically pull the bush toward an inside of the dryer.

55. The dryer of claim 46, wherein the fixing member is engaged with the bush with being elastically deformed.

56. The dryer of claim 46, wherein the fixing member is curved.

57. The dryer of claim 37, wherein the installation assembly further comprises an auxiliary insertion hole for a power cord directly connected with inner devices of the dryer without the terminal block.

58. The dryer of claim 57, wherein the auxiliary insertion hole is formed at any one of upper corners of the rear wall.

59. The dryer of claim 57, wherein the auxiliary insertion hole is closed, and is configured to be able to be opened if necessary.

60. The dryer of claim 57, wherein the auxiliary insertion hole comprises a cover covering the auxiliary insertion hole, and a rib connecting the cover with the rear wall and configured to be able to be cut.
